(19) United States
(12) Patent Application Publication
(10) Pub. No.: US 2005/0264208 A1
(43) Pub. Date: Dec. 1, 2005

(54) Plasma display panel with reduced capacitance between display electrodes

(76) Inventors: Jae-Ik Kwon, Suwon-si (KR); Kyoung-Doo Kang, Suwon-si (KR)

Correspondence Address: CHRISTIE, PARKER & HALE, LLP, PO BOX 7068, PASADENA, CA, 91109-7068, US

(21) Appl. No.: 11/134,789

(22) Filed: May 21, 2005

(30) Foreign Application Priority Data
May 31, 2004 (KR) 10-2004-0038940

(51) Int. Cl. H01J 17/49

(52) U.S. Cl. 313/586

(57) ABSTRACT

A plasma display panel includes front and rear substrates, barrier ribs, a phosphor layer, address, sustain and scan electrodes, and a dielectric layer. Barrier ribs between the front and rear substrates divide the space in between into discharge cells. The sustain and scan electrodes face each other in each discharge cell forming a discharge gap and are asymmetrical with respect to at least one of the center axes of the discharge cell. The dielectric layer covers the sustain and scan electrodes. The distance between the electrodes can be increased and therefore the capacitance between electrodes decreased while maintaining the discharge gap. As a result, reactive power consumption of the panel can be decreased, and distribution of wall charges during the reset period can be controlled even when applying a low voltage of simple waveform to initiate reset.

### CROSS-REFERENCE TO RELATED APPLICATION

This application claims priority to and the benefit of Korean Patent Application 10-2004-0038940 filed in the Korean Intellectual Property Office on May 31, 2004, the entire content of which is incorporated herein by reference.

### BACKGROUND OF THE INVENTION

1. Field of the Invention

The present invention relates to a plasma display panel (PDP). More particularly, the present invention relates to a PDP in which capacitance between electrodes has been lowered.

2. Description of the Related Art

A PDP, which is typically provided with hundreds of thousands to millions of discharge cells in a matrix format, is a thin film display device displaying images through a plasma discharge generated in the discharge cells. In a conventional 3-electrode surface discharge type PDP, an address electrode, a barrier rib, and a phosphor layer of red, green, or blue color are located on a rear substrate corresponding to a discharge cell. A scan electrode and a sustain electrode are located on a front substrate along a direction crossing the address electrode. The scan electrode and the sustain electrode are covered with a dielectric layer and a protective layer. An inner space of the discharge cell is filled with a discharge gas, typically Ne—Xe compound gas, to form the PDP.

A plasma discharge by the discharge gas is generated by a voltage applied to the scan electrode and the sustain electrode within the discharge cell of the PDP, and the phosphor is lit by ultraviolet rays generated during the plasma discharge, thereby displaying images.

One of the most serious drawbacks of such a conventional PDP is poor energy conversion efficiency. Poor energy conversion efficiency is mainly caused by the fact that reactive power consumption, that is the electrical energy consumption while the panel is not operating, is relatively high as explained in more detail below.

The conventional PDP includes hundreds of thousands of discharge cells. A pair of electrodes is formed to correspond to each discharge cell. These electrodes are typically made from electrically conductive metallic material. In order to protect the electrodes, the electrodes are covered with a dielectric material.

A structure where the dielectric material is placed between the metal electrodes creates a capacitor. Therefore, the PDP may be considered as a device having a number of capacitors corresponding to the number of discharge cells. Electrical energy corresponding to the capacitance of a capacitor is additionally stored in the capacitor. Therefore, overall power consumption of the PDP is increased by the amount of reactive power consumption corresponding to the amount of electrical energy stored in the capacitors.

### SUMMARY OF THE INVENTION

The present invention decreases the capacitance between PDP display electrodes by improving electrode arrangement. The arrangements used increase the distance between capacitor plates formed by the display electrodes while maintaining the gap between the display electrodes small. The small gap is necessary for a strong reset discharge during a reset period. Furthermore, the display electrodes are shaped to increase charge collection at the boundaries adjacent the gap thus further enhancing a reset discharge. So, while the effective distance between the display electrode is increased for capacitance purposes, the discharge gap remains the same. And, while reactive energy consumption is reduced by decreasing the capacitance of the capacitors formed, the reset discharge is not impacted.

An exemplary PDP according to an embodiment of the present invention includes a front substrate and a rear substrate, barrier ribs, address electrodes, a phosphor layer, sustain electrodes and scan electrodes, and a dielectric layer. The front and rear substrates face each other. The barrier ribs are located between the front and rear substrates and dividedly form a plurality of discharge cells. The address electrodes are formed corresponding to the discharge cells. The phosphor layer is formed in the discharge cells. Display electrodes include sustain and scan electrodes. A sustain electrode and a scan electrode face each other in each discharge cell to form a discharge gap and are formed to be asymmetrical with respect to at least one of a center axis of the discharge cell along a longitudinal direction of the discharge cell and a center axis of the discharge cell along a width of the discharge cell. The dielectric layer covers the sustain electrodes and the scan electrodes.

The sustain electrodes and the scan electrodes may be staggered and formed to deviate in opposite directions with respect to an elongation direction of the address electrodes.

The sustain electrodes and the scan electrodes may geometrically form a point symmetrical with respect to a planar center of the discharge cells.

Each of the sustain electrodes and the scan electrodes may include a bus electrode formed by being extended along a direction crossing the address electrodes, and a transparent electrode extended toward the inside of the discharge cells from the bus electrode and forming a discharge gap. The transparent electrode may be formed to be asymmetrical with respect to at least one of the center axes of the discharge cell along the longitudinal direction of the discharge cell and the center axis of the discharge cell along the width of the discharge cell.

A portion of the transparent electrode may be partially removed at a portion contacting the bus electrode, and the transparent electrode may form the discharge gap by protruding along an elongation direction of the address electrode from the bus electrode and then being extended toward the inside of the discharge cell.

The transparent electrode may be partially formed on a barrier rib.

Alternatively, the transparent electrode may be formed to over a pair of neighboring discharge cells across the barrier rib.

A center of the transparent electrode may lie on the barrier rib.

A center of the transparent electrode of the scan electrode and a center of the transparent electrode of the sustain electrode may be alternately positioned along the barrier ribs.

An opening may be formed by selectively removing a portion of the transparent electrode contacting the bus electrode within the discharge cell, and the transparent electrode may form the discharge gap by being extended along the barrier rib and then branching into a pair of neighboring discharge cells.

### BRIEF DESCRIPTION OF THE DRAWINGS

FIG. 1 is a partial exploded perspective view of a PDP according to an embodiment of the present invention.

FIG. 2 is a plan view showing the relationship between a display electrode and a barrier rib of the PDP of FIG. 1.

FIG. 3 is a plan view of an exemplary variation of the electrodes of FIG. 2.

FIG. 4 is a plan view showing the relationship between a display electrode and a barrier rib of a PDP according to another embodiment of the present invention.

FIG. 5 is a plan view of an exemplary variation of the electrodes of FIG. 4.

### DETAILED DESCRIPTION

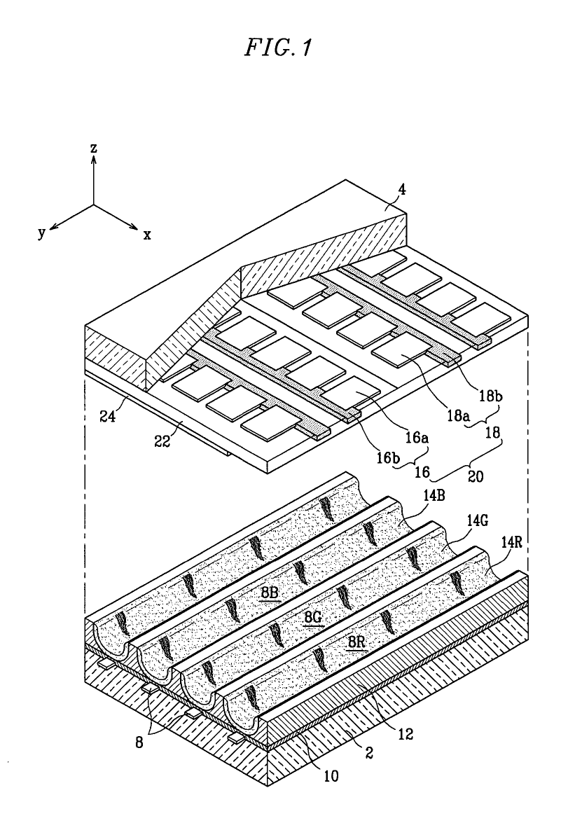

As shown in FIG. 1, the PDP according to one embodiment of the invention, includes a front substrate 4 and a rear substrate 2, located facing each other, and discharge cells 8R, 8G, 8B, that are formed by barrier ribs 12 between the two substrates 2, 4. Address electrodes 8 are extended along a direction, for example, the y direction, crossing a width of the discharge cells 8R, 8G, 8B, that may for example lie along the x direction. The address electrodes 8 are located in parallel with other neighboring address electrodes 8 and are placed apart by a constant gap.

The address electrodes 8 are formed on an inner surface of the rear substrate 2. A dielectric layer 10 is formed over the inner surface of the rear substrate 2 covering the address electrodes 8. The barrier ribs 12 are formed over the dielectric layer 10. Phosphor layers 14R, 14G, and 14B, of red, green, and blue colors, are applied on walls of the barrier ribs 12 and the dielectric layer 10, thereby forming the discharge cells 8R, 8G, 8B.

In FIG. 1, the barrier ribs 12 are illustrated as stripe type barrier ribs that extend in parallel with one another along the y axis of the drawing. The present invention, however, is not limited to this configuration. For example, the present invention may also be applied to a structure in which discharge cells are formed in a lattice formed by first barrier rib members extending in parallel with the address electrodes and second barrier rib members crossing the first barrier rib members.

In addition, on the front substrate 4 facing the rear substrate 2, display electrodes 20, each including a scan electrode 16 and a sustain electrode 18, are formed along a direction, for example the x direction of the figure, crossing the address electrodes 8. A dielectric layer 22 and a protective layer 24 are consecutively formed over the entire inner surface of the front substrate 4 covering the display electrodes 20.

In the present embodiment, the display electrodes 20 include transparent electrodes 16a and 18a, and bus electrodes 16b and 18b. The transparent electrodes 16a and 18a face each other in the discharge cells 8R, 8G, 8B and form a discharge gap. These electrodes may be made of a transparent material such as Indium Tin Oxide (ITO) in order to enhance an aperture ratio. In addition, the bus electrodes 16b and 18b may be made of metallic material such as chromium and copper in order to compensate for the high electrical resistance of the transparent electrodes 16a and 18a.

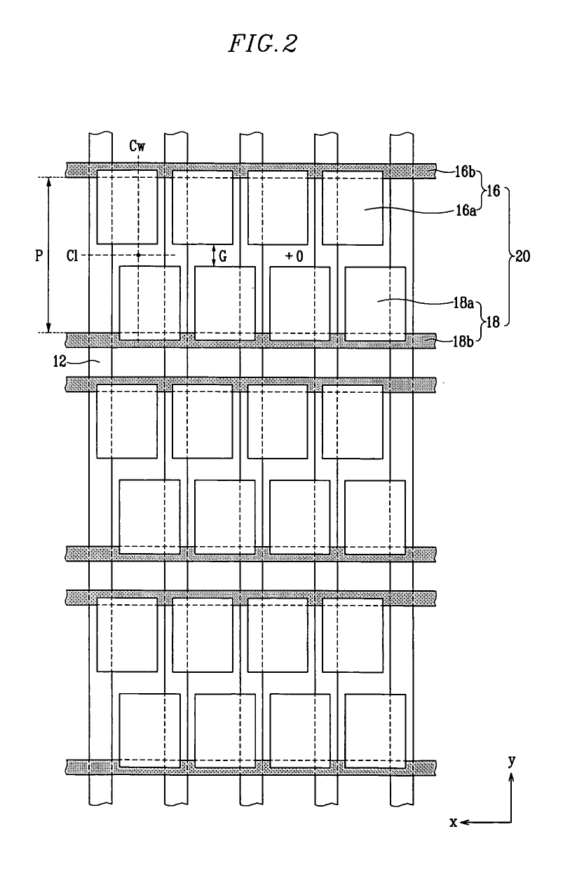

As shown in FIGS. 2 to 5, in various embodiments and exemplary variations of the present invention, the scan electrodes 16 and the sustain electrodes 18 are formed to be asymmetrical with respect to at least one of a center axis Cl of the discharge cells 8R, 8G, 8B, along a length of the discharge cells and a center axis Cw of the discharge cells along a width of the discharge cells.

For example, as shown in the drawings, the sustain electrodes 18 and the scan electrodes 16 are formed in a staggered manner and deviate in opposite directions with respect to a length direction of the address electrodes, i.e. the y direction in the drawings.

Furthermore, each display electrode 20, which is realized by a combination of transparent electrodes 16a, 18a and bus electrodes 16b, 18b, may be formed such that they are symmetrical with respect to a planar center of the discharge cell. As a result, a surface discharge can be formed using the longest distance of the discharge cell. At the same time, the area where the scan electrode 16 and the sustain electrode 18 face each other can be decreased, so that power consumption due to a capacitance formed between the two electrodes is decreased.

The front substrate 4 and the rear substrate 2 are positioned such that the address electrodes 8 and the display electrodes 20 cross each other in the discharge cells 8R, 8G, 8B. Each discharge cell is filled with a discharge gas, e.g., Ne—Xe compound gas, that introduces radiation of an ultraviolet ray as a result of a plasma discharge.

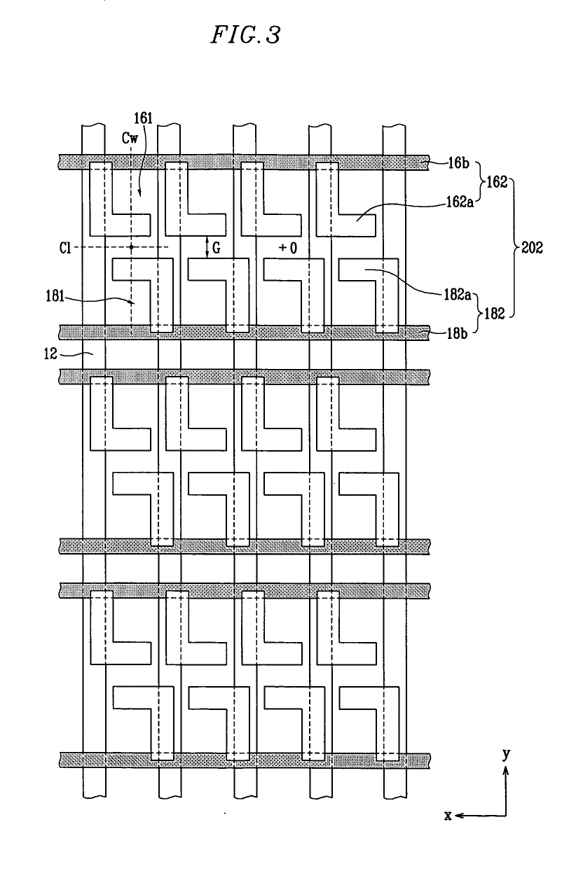

FIG. 2 and FIG. 3 show the display electrodes 20 according to the first embodiment of the present invention. A plurality of barrier ribs 12 partitioning the discharge cells 8R, 8G, 8B, are formed along the direction of the address electrodes, that is the y direction in the figures. Neighboring barrier ribs 12 are set apart from one another by a constant gap.

The scan electrodes 16 and the sustain electrodes 18 are formed facing each other along a direction crossing the barrier ribs 12, that is the x direction in the figures. The display electrodes 20 are formed as a combination of the transparent electrodes 16a, 18a and the bus electrodes 16b, 18b, as mentioned above.

In more detail, the bus electrodes 16b, 18b, forming the scan electrodes 16 and the sustain electrodes 18, extend in a direction, i.e. the x direction in the drawings, crossing the barrier ribs 12 while maintaining a constant gap between the two electrodes 16, 18. This gap is shown as a pitch P of the discharge cells 8R, 8G, 8B in a direction along the y axis, in FIG. 2.

The transparent electrodes 16a, 18a are individually formed for each discharge cell 8R, 8G, 8B. These transparent electrodes 16a, 18a are formed by being extended into the discharge cells 8R, 8G, 8B, while one end is electrically connected to the bus electrodes 16b, 18b. Accordingly, the transparent electrodes 16a, 18a, forming the scan electrodes 16 and the sustain electrodes 18, face each other within the discharge cells 8R, 8G, 8B and form a discharge gap G.

The transparent electrodes 16a, 18a are formed to be asymmetrical in a discharge cell 8R, 8G, 8B with respect to at least one of the center axes of the discharge cell. The axis along the longitudinal direction and dividing a width of the discharge cell is shown as Cw. The axis along the lateral direction and dividing a length of the discharge cell is shown as Cl. A reference sign “0” in the drawings denotes a plan view of a center of the discharge cell where the two axes intersect. The transparent electrodes 16a, 18a are formed to be symmetrical with respect to this center point 0.

In the drawings, the transparent electrodes 16a, forming the scan electrodes 16, are staggered and deviate from the center axis Cw in one direction. That is, in plan view, center axis Cw of the discharge cells 8R, 8G, 8B does not pass through the center of the transparent electrodes 16a. Rather, the transparent electrodes deviate to one side of the center axis Cw of the discharge cells 8R, 8G, 8B.

On the other hand, the transparent electrodes 18a, forming the sustain electrodes 18, are staggered and deviate from the center axis Cw in a direction opposite to transparent electrodes 16a of the scan electrodes 16. That is, the transparent electrodes 16a of the scan electrodes 16 and the transparent electrodes 18a of the sustain electrodes 18 are staggered and deviate from the center line of the discharge cell 8R, 8G, 8B toward opposite barrier ribs 12 of a pair of barrier ribs 12 partitioning the discharge cell 8R, 8G, 8B. Accordingly, the transparent electrodes 18a and the transparent electrodes 16a of the scan electrodes 16 are asymmetrical with respect to the center axis Cw of the discharge cells.

Since the transparent electrodes 16a and 18a are formed staggered and deviate from the center axis Cw of the discharge cells 8R, 8G, 8B, in opposite directions, a portion of the transparent electrodes 16a, 18a may lie on the barrier ribs 12. Although in the embodiment shown in the drawings, a portion of the transparent electrodes 16a, 18a lies on the barrier rib, the present invention is not restricted to this configuration.

Because the transparent electrodes 16a, 18a, forming the discharge gap G, are formed to be asymmetrical with respect to one of the center axes of the discharge cells 8R, 8G, 8B, capacitance between the scan electrodes 16 and the sustain electrodes 18 can be lowered while maintaining the discharge gap G. Lowering this capacitance substantially decreases the reactive power consumption.

The reason why the capacitance may be lowered is explained by referring to Equation 1 below.

$$C = ɛ \frac{A}{d} \qquad [ Equation 1 ]$$

Capacitance of a capacitor can be obtained from Equation 1 where “C” denotes the capacitance typically formed between two parallel plates that are separated by a dielectric. “A” denotes the area of electrode plates, “d” denotes the distance between the electrode plates, and “ε” denotes the dielectric constant of the dielectric between the electrode plates. According to the Equation 1, capacitance is proportional to the area of plates and inversely proportional to the distance between the plates. In the embodiments of this invention, the electrodes of the PDP serve as capacitor plates.

Because in the embodiments of the present invention, the scan and sustain electrodes 16, 18 are formed to be asymmetrical with respect to a center axes Cw, Cl of the discharge cells, a distance between the electrodes can be greater than that of a conventional 3-electrode surface discharge type PDP in which the scan and sustain electrodes are formed to be symmetrical with respect to the center axes Cw, Cl of the discharge cells. As Equation 1 indicates, an increase in the distance between the plates decreases the capacitance between the electrodes. Therefore, in embodiments of the invention, the capacitance between the scan and sustain electrodes 16, 18 is decreased as compared to the electrode structure of conventional PDP devices.

FIG. 3 shows another embodiment of the present invention where a portion of transparent electrodes 162a and 182a may be removed. Removing removed portions 161, 181 contacting the bus electrodes 16b, 18b may leave L-shaped transparent electrodes 162a, 182a. Removed portions 161, 181 may have a rectangular shape, and accordingly, the remaining transparent electrodes 162a, 182a extend along the barrier ribs 12 from the bus electrodes 16b, 18b and then protrude into the discharge cells 8R, 8G, 8B near the planar center O of the discharge cells 8R, 8G, 8B. Therefore, in each display electrode 202, according to the present embodiment, the transparent electrodes 162a, 182a face each other near the discharge gap G, but a part of the rear portion of the transparent electrodes 162a, 182a is removed.

Distribution of wall charges can be easily controlled on the display electrode 202 with L-shaped transparent electrodes 162a, 182a described above.

In address and display separated (ADS) driving, a reset period is a period for resetting wall charges. During the reset period, wall charges are reset by generating a weak discharge using a relatively low voltage. Because in the conventional PDP, a weak electric field is generated at end portions of the discharge cells 8R, 8G, 8B it is difficult to control the wall charges. In order to solve this problem and achieve an effective reset, a high voltage of complicated waveform is needed.

However, in the display electrode 202, according to the present embodiment, at least the portion of the transparent electrodes 162a, 182a where they contact the bus electrodes 16b, 18b is removed. As a result, wall charges rarely exist on both ends of the discharge cell 8R, 8G, 8B. Wall charges rather exist mainly near the discharge gap G generating a strong discharge. Therefore, according to the present embodiment, distribution of the wall charges can be controlled using a low voltage of simple waveform.

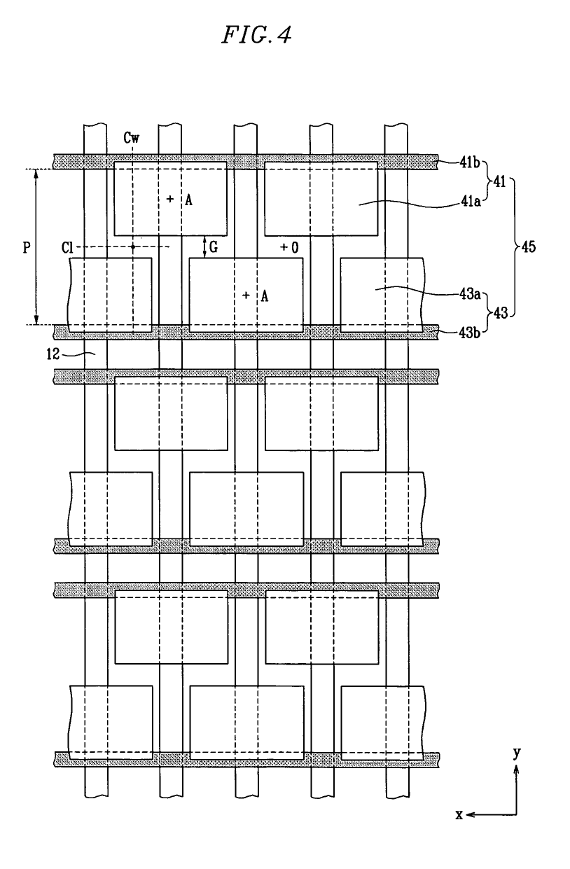

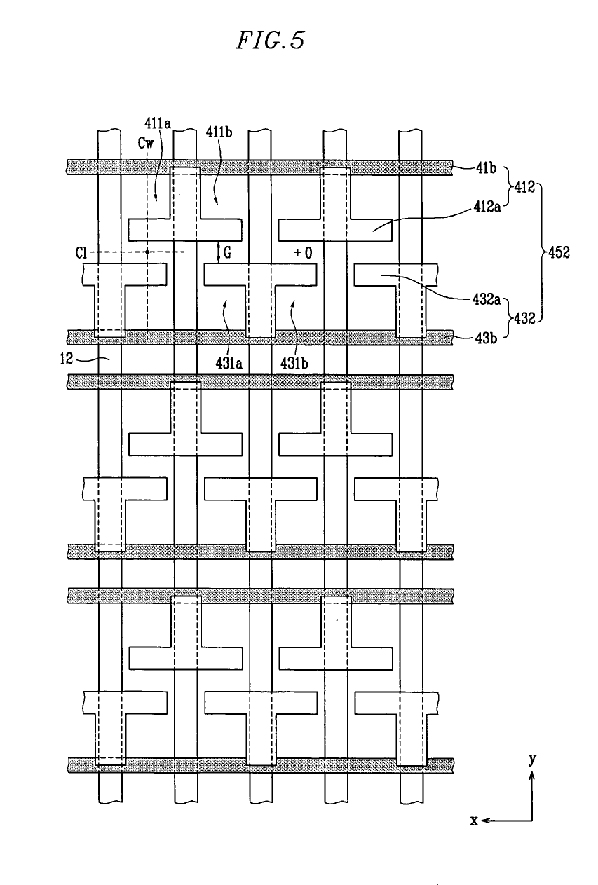

Referring to FIGS. 4 and 5, display electrodes 45, 452 according to the second embodiment of the present invention will be explained in detail. FIGS. 4 and 5 are electrode layout views selectively illustrating barrier ribs and display electrodes of a PDP. A scan electrode 41, 412 and a sustain electrode 43, 432 are formed as a combination of transparent electrodes 41a, 412a, 43a, 432a and bus electrodes 41b and 43b.

The bus electrodes 41b and 43b extend along a direction crossing the barrier ribs 12, the x direction in the drawings, while maintaining a constant gap between the bus electrodes and the barrier ribs 12. The gap corresponds to a pitch P of the discharge cell 8R, 8G, 8B along the y direction in the drawings.

The transparent electrodes 41a, 412a, 43a, 432a extend into the discharge cell 8R, 8G, 8B while electrically connected to the bus electrodes 41b, 43b at one end. The transparent electrodes 41a, 412a, 43a, 432a are formed such that each lie over a pair of neighboring discharge cells 8R, 8G, 8B across the barrier ribs 12.

Center A of the transparent electrodes 41a, 412a, 43a, 432a lies on the barrier ribs 12, and this allows electrodes having the same size to be formed for each discharge cell. Accordingly, in the present embodiment, the transparent electrodes 41a, 412a, 43a, 432a are formed between a pair of neighboring discharge cells each crossing the barrier ribs 12.

Centers A of the transparent electrodes 41a, 412a of the scan electrodes 41, 42 and the transparent electrodes 43a, 432a of the sustain electrodes 43, 432 are alternately positioned on the barrier ribs 12. That is, each transparent electrode 41a, 412a of the scan electrodes 41, 412 is formed across a barrier rib 12, and the center of the transparent electrode 41a, 412a is positioned on the barrier rib 12. Each transparent electrode 43a, 432a of the sustain electrodes 43, 432 is formed across a neighboring barrier rib 12, and the center of the transparent electrode 43a, 432a is positioned on the neighboring barrier rib 12. Accordingly, along the x direction in the drawing, centers A of the transparent electrodes 41a, 412a, 43a, 432a of the scan electrodes 41, 412 and the sustain electrodes 43, 432 are alternately located on the barrier ribs 12.

FIG. 5 shows an exemplary variation of the second embodiment. A portion of the transparent electrodes 41a and 43a contacting the bus electrodes 41b and 43b may be removed, so that openings 411a, 411b, 431a, and 431b are formed in the discharge cells 8R, 8G, 8B. The transparent electrodes 412a, 432a thus formed are T-shaped, extending along the barrier ribs 12 and branching into a pair of neighboring discharge cells 8R, 8G, 8B.

In various embodiments of the present invention, the distance between the electrodes can be increased and therefore the capacitance between electrodes substantially decreased while maintaining the discharge gap between the sustain electrode and the scan electrode. As a result, reactive power consumption of the panel can be decreased, and distribution of wall charges during the reset period can be easily controlled even when applying a low voltage of simple waveform to initiate reset.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A plasma display panel comprising:
a front substrate and a rear substrate facing each other and forming a space between front and rear substrates;
barrier ribs located between the front and rear substrates dividing the space formed in between the front and rear substrates into discharge cells, the discharge cells having a longitudinal center axis and a lateral center axis;
display electrodes including pairs of a sustain electrode and a scan electrode formed on the front substrate, sustain and scan electrodes of each pair facing each other in each of the discharge cells forming a discharge gap in between the sustain and scan electrodes;
address electrodes formed on the rear substrate corresponding to the discharge cells, the address electrodes crossing paths with the sustain and scan electrodes;
a phosphor layer formed lining the discharge cells; and
a dielectric layer covering the sustain and scan electrodes,
wherein the sustain and scan electrodes of each pair facing each other are arranged asymmetrically with respect to at least one of the longitudinal center axis or the lateral center axis of a discharge cell.

2. The plasma display panel of claim 1, wherein the sustain electrodes and the scan electrodes in each pair facing each other are staggered and deviate in opposite directions from the longitudinal center axis of the discharge cells.

3. The plasma display panel of claim 2, wherein the sustain electrodes and the scan electrodes in each pair facing each other are symmetrical with respect to a center of the discharge cell.

4. The plasma display panel of claim 1,
wherein each of the sustain and scan electrodes includes a bus electrode extending along a direction crossing the address electrodes, and a transparent electrode extending from the bus electrode toward an inside of the discharge cells and forming the discharge gap between the transparent electrode of the sustain electrode and the transparent electrode of the scan electrode; and
wherein the transparent electrode is formed to be asymmetrical with respect to at least one of the longitudinal center axis or the lateral center axis of the discharge cells.

5. The plasma display panel of claim 4, wherein a portion of the transparent electrode is removed where the transparent electrode connects to the bus electrode.

6. The plasma display panel of claim 5, wherein the transparent electrode is L-shaped forming the discharge gap by protruding from the bus electrode along the address electrodes and then extending toward a center of the discharge cell.

7. The plasma display panel of claim 4, wherein the transparent electrode is partially formed on the barrier rib.

8. The plasma display panel of claim 4, wherein the transparent electrode is formed over a pair of neighboring discharge cells across the barrier rib.

9. The plasma display panel of claim 8, wherein a center axis of the transparent electrode extends along the barrier rib.

10. The plasma display panel of claim 9, wherein the center axes of the transparent electrodes of the scan electrodes and the center axes of the transparent electrodes of the sustain electrodes are alternately positioned along the barrier ribs.

11. The plasma display panel of claim 10, wherein a portion of the transparent electrode contacting the bus electrodes within the discharge cells is removed.

12. The plasma display panel of claim 11, wherein the transparent electrode is T-shaped forming the discharge gap by extending along the barrier rib and branching into a pair of neighboring discharge cells.
